(19) United States
(12) Patent Application Publication
(10) Pub. No.: US 2026/0298719 A1
(43) Pub. Date: Oct. 1, 2026

(54) ELECTROMAGNETIC WAVE DETECTION ELEMENT AND ELECTROMAGNETIC WAVE SENSOR PROVIDED WITH SAME

(71) Applicant: TDK Corporation, Tokyo (JP)

(72) Inventors: Susumu AOKI, Tokyo (JP); Eiji KOMURA, Tokyo (JP); Shinji HARA, Tokyo (JP); Naoki OHTA, Tokyo (JP); Takahiro NAKAGAWA, Tokyo (JP)

(73) Assignee: TDK Corporation, Tokyo (JP)

(21) Appl. No.: 19/537,773

(22) Filed: Feb. 12, 2026

(30) Foreign Application Priority Data
Mar. 25, 2025 (JP) 2025-050197

(51) Int. Cl. G01J 5/20

(52) U.S. Cl. CPC G01J 5/20; G01J 2005/202

(57) ABSTRACT

An electromagnetic wave detection element comprises a bolometer that includes an electromagnetic wave absorber, and an arm part that includes a wiring layer that is electrically connected to the bolometer. A part of the arm part is arranged with a first gap between the arm part and the bolometer, and the electromagnetic wave absorber includes a first protruding part and a second protruding part adjacent to each other in a first direction and separated by a second gap.

### FIELD

This application claims the benefit of Japanese Priority Patent Application No. 2025-050197 filed on Mar. 25, 2025, the entire contents of which are incorporated herein by reference.

The present disclosure relates to an electromagnetic wave detection element and an electromagnetic wave sensor provided with same.

### BACKGROUND

JP 2022-126582 A describes an electromagnetic wave sensor that detects electromagnetic waves. The electromagnetic wave sensor comprises an electromagnetic wave detector that detects electromagnetic waves and that includes an electromagnetic wave absorber, and two arm parts that are electrically connected to the electromagnetic wave detector. The electromagnetic wave absorber increases the absorption efficiency of electromagnetic waves absorbed by the electromagnetic wave detector. The electromagnetic wave absorber has a relatively simple shape, such as a rectangle, when viewed from the direction of film thickness.

### SUMMARY

The electromagnetic wave detection element of the present disclosure comprises a bolometer that includes an electromagnetic wave absorber, and an arm part that includes a wiring layer electrically connected to the bolometer. A part of the arm part is arranged with a first gap between the arm part and the bolometer, and the electromagnetic wave absorber includes a first protruding part and a second protruding part adjacent to each other in a first direction and separated by a second gap.

### BRIEF DESCRIPTION OF THE DRAWINGS

The accompanying drawings are included to provide a further understanding of the disclosure and are incorporated in and constitute a part of this specification. The drawings illustrate example embodiments and together with the specification explain the principles of the technology.

FIG. 1 is a schematic side view of an electromagnetic wave sensor according to a first embodiment of the present disclosure;

FIG. 2 is a partial schematic plan view of the electromagnetic wave sensor shown in FIG. 1;

FIGS. 3A to 3C are a partial schematic enlarged view and partial schematic cross-sectional views of the electromagnetic wave detection element shown in FIG. 2;

FIG. 4 is an enlarged view of area A in FIG. 3;

FIGS. 5A and 5B are schematic plan views of the electromagnetic wave detection element of Comparative Examples 1 and 2;

FIGS. 6A to 6C are a schematic plan view and schematic cross-sectional views of the electromagnetic wave detection element of a first modification of the first embodiment;

FIGS. 7A to 7C are a schematic plan view and schematic cross-sectional views of the electromagnetic wave detection element of a second modification of the first embodiment;

FIGS. 8A to 8D are partial schematic plan views of the electromagnetic wave detection element of a third modification of the first embodiment;

FIG. 9 is a schematic cross-sectional view of the electromagnetic wave detection element of a fourth modification of the first embodiment;

FIG. 10 is a schematic cross-sectional view of the electromagnetic wave detection element of a fifth modification of the first embodiment;

FIG. 11 is a schematic side view of the electromagnetic wave sensor according to a second embodiment of the present disclosure; and

FIG. 12 is a schematic side view of the electromagnetic wave sensor according to a modification of the second embodiment.

### DETAILED DESCRIPTION

The electromagnetic wave absorption performance of an electromagnetic wave absorber increases with increase of the area of incidence of electromagnetic waves to be measured. However, the larger the area of incidence, the larger the volume of the electromagnetic wave absorber, and thus, the lower the ability of the electromagnetic wave detector to follow temperature changes that occur in response to fluctuations in electromagnetic wave intensity.

It is desirable to provide an electromagnetic wave detection element having the ability to closely follow temperature changes resulting from fluctuations in electromagnetic wave intensity.

Embodiments of an electromagnetic wave detection element of the present disclosure and an electromagnetic wave sensor provided with more than one of the electromagnetic wave detection element will be described with reference to the drawings. The electromagnetic wave detection element of the present disclosure detects electromagnetic waves. The drawings are schematic diagrams illustrating the present disclosure, and the shapes and sizes of the elements in the drawings may not match. In the following description and drawings, the X-direction (also referred to as the “first direction”) and the Y-direction are parallel to principal surface 1A of first substrate 1 and principal surface 2A of second substrate 2. Principal surfaces 1A and 2A are surfaces of first substrate 1 and second substrate 2, respectively, that face each other. The X-direction and the Y-direction are orthogonal to each other. The Z-direction is orthogonal to the X-direction and the Y-direction and is perpendicular to principal surface 1A of first substrate 1 and principal surface 2A of second substrate 2 or is the direction of film thickness of electromagnetic wave detector 21.

The following embodiments will be directed to an infrared sensor in which electromagnetic wave detection elements 11 are arranged in a two-dimensional array. The infrared sensor mainly detects infrared rays with wavelengths of approximately 8 to 14 μm. Infrared sensors of this type are generally used as image sensors for infrared cameras. An infrared camera can be used as a night vision scope or night vision goggles in dark places and can also be used to measure the temperature of people or objects. An infrared sensor in which electromagnetic wave detection elements 11 are arranged as a one-dimensional array can also be used as a sensor to measure various temperatures or temperature distributions. Although an explanation is here omitted, an infrared sensor in which electromagnetic wave detection elements 11 are arranged in a one-dimensional array is also included in the scope of the present disclosure. The electromagnetic waves to be detected are not limited to infrared rays but may be, for example, terahertz waves with wavelengths of from 100 μm to 1 mm.

### First Embodiment

### Overall Configuration

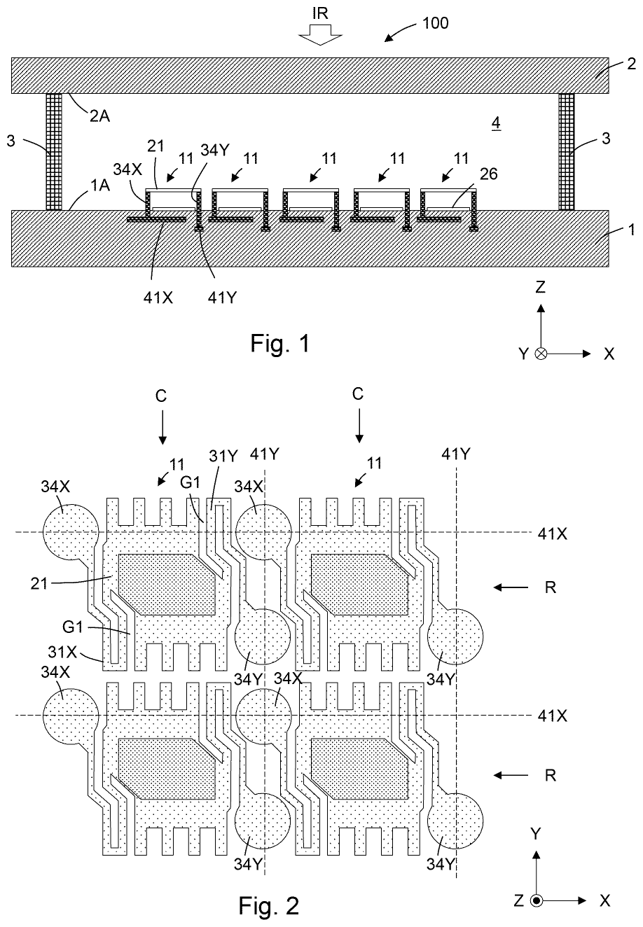

FIG. 1 is a schematic side view of electromagnetic wave sensor 100. In FIG. 1, first and second arm parts 31X and 31Y are not shown. In FIG. 1, five electromagnetic wave detection elements 11 are arranged in the X-direction, but as described below, the number of electromagnetic wave detection elements 11 is not limited. Electromagnetic wave sensor 100 comprises first substrate 1 and second substrate 2 that are arranged opposite each other, and side walls 3 that both connect and surround first substrate 1 and second substrate 2 in the circumferential direction. First substrate 1, second substrate 2, and side walls 3 form a sealed internal space 4. Electromagnetic wave detection elements 11 that function as the sensing parts of electromagnetic wave sensor 100 are provided in internal space 4. Because internal space 4 is under negative pressure or in a vacuum, this configuration can prevent or reduce convection of gases in internal space 4 and thus reduces thermal effects on electromagnetic wave detection elements 11.

First substrate 1 is formed generally of a silicon substrate and supports electromagnetic wave detection elements 11. First substrate 1 is equipped with internal wiring and electrical circuits such as readout IC (ROIC) that read out the output signals of electromagnetic wave detection elements 11 (internal wiring and electrical circuits are not shown). Pads (not shown) are formed on the outside of side walls 3 of first substrate 1 for input to and output from the outside. The pads are electrically connected to electrical circuits by internal wiring. Second substrate 2 is also formed generally of a silicon substrate and constitutes the portion of the input of electromagnetic waves IR. Second substrate 2 is the substrate on the side of incidence of electromagnetic waves IR to be detected. Second substrate 2 transmits electromagnetic waves IR and thus allows electromagnetic waves IR to enter electromagnetic wave detection elements 11. First substrate 1 and second substrate 2 may be germanium substrates that transmit electromagnetic waves.

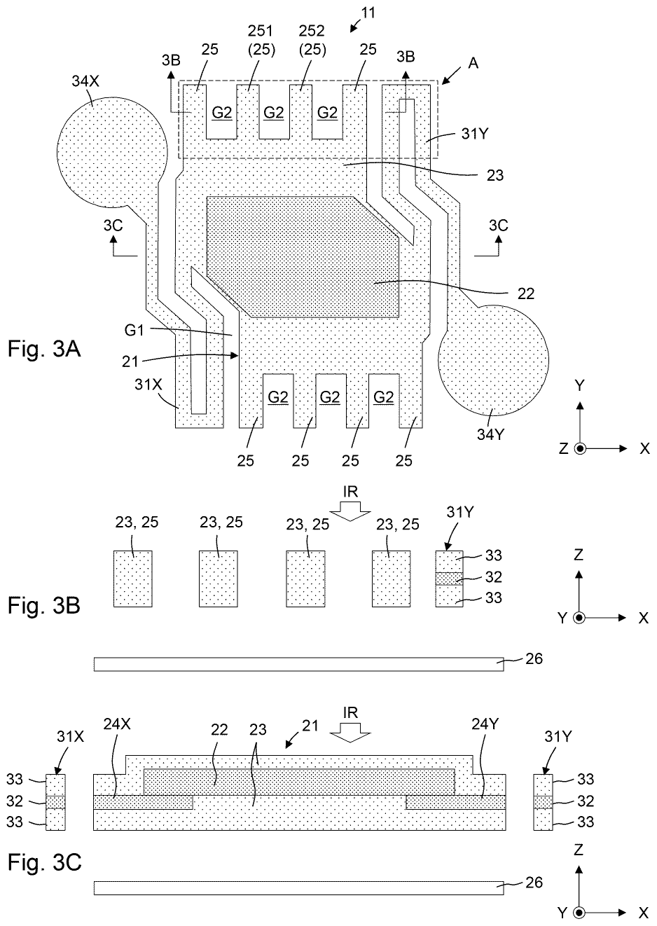

FIG. 2 is a partial plan view of electromagnetic wave sensor 100 viewed in the Z-direction and also schematically shows first wirings 41X and second wirings 41Y. FIG. 3A is a schematic plan view of one electromagnetic wave detection element 11, FIG. 3B is a schematic cross-sectional view taken along line 3B-3B of FIG. 3A, and FIG. 3C is a schematic cross-sectional view taken along line 3C-3C of FIG. 3A. In FIGS. 2 and 3A, temperature detection elements 22 are shown for convenience. Electromagnetic wave detection elements 11 are arranged in an array, for example, a two-dimensional grid-like array comprising rows R extending in the X-direction and columns C extending in the Y-direction. Temperature detection element 22 (see below) of each electromagnetic wave detection element 11 constitutes one cell or pixel in this array. The number of matrices in the array includes, but is not limited to, for example, 640 rows by 480 columns or 1024 rows by 768 columns. First substrate 1 includes first wirings 41X extending in the X-direction and second wirings 41Y extending in the Y-direction. First wirings 41X and second wirings 41Y are provided inside first substrate 1, are electrically connected to the ROIC, and extend at different positions from each other in the Z-direction.

### Configuration of Electromagnetic Wave Detection Element 11

As shown in FIGS. 2 and 3A to 3C, each electromagnetic wave detection element 11 comprises electromagnetic wave detector 21, first arm part 31X, and second arm part 31Y, each arm part having one end connected to electromagnetic wave detector 21 to support electromagnetic wave detector 21. Each of first and second arm parts 31X and 31Y includes wiring layer 32 that is electrically connected to temperature detection element 22 of electromagnetic wave detector 21, and two dielectric layers 33 that sandwich wiring layer 32 in the Z-direction. Wiring layer 32 can be made of, for example, a metal such as titanium or a conductive nitride such as titanium nitride. The two dielectric layers 33 can be made of, for example, the same material as electromagnetic wave absorber 23 (to be described) of electromagnetic wave detector 21. Wiring layer 32 of first arm part 31X is electrically connected to first conductive pillar 34X, and wiring layer 32 of second arm part 31Y is electrically connected to second conductive pillar 34Y. A part of first arm part 31X and a part of second arm part 31Y are arranged separated from electromagnetic wave detector 21 by first gap G1. In the example shown in FIGS. 2 and 3A, first gap G1 is a gap between a part of first arm part 31X and electromagnetic wave detector 21 that are adjacent in the X-direction or is a gap between a part of second arm part 31Y and electromagnetic wave detector 21 that are adjacent in the X-direction. The length of first gap G1 in the X-direction need not be constant and may vary depending on the position. The length in the X-direction of first gap G1 between first arm part 31X and electromagnetic wave detector 21 and the length in the X-direction of first gap G1 between second arm part 31Y and electromagnetic wave detector 21 are the same but may be different.

Each electromagnetic wave detection element 11 has first and second cylindrical conductive pillars 34X and 34Y. First conductive pillar 34X is electrically connected to a corresponding first wiring 41X, and second conductive pillar 34Y is electrically connected to a corresponding second wiring 41Y. First conductive pillar 34X supports first arm part 31X and thus supports electromagnetic wave detector 21 via first arm part 31X. Second conductive pillar 34Y supports second arm part 31Y and thus supports electromagnetic wave detector 21 via second arm part 31Y. First conductive pillar 34X is electrically connected to wiring layer 32 of first arm part 31X, and second conductive pillar 34Y is electrically connected to wiring layer 32 of second arm part 31Y.

Each electromagnetic wave detector 21 comprises temperature detection element 22, electromagnetic wave absorber 23, and first and second electrode layers 24X and 24Y. Electromagnetic wave detector 21 absorbs incoming electromagnetic waves and converts them into heat for detection. Electromagnetic wave detector 21 is a bolometer. The electromagnetic waves incident to electromagnetic wave detector 21 are absorbed by electromagnetic wave absorber 23 and converted into heat, and the change in intensity of the electromagnetic waves incident to electromagnetic wave detector 21 is detected by temperature detection elements 22 as a temperature change. Temperature detection element 22 is a thermistor film. The shape of temperature detection element 22 viewed from the Z-direction is a rectangle with two opposite corners cut off, but the shape can also be square, rectangular, or rectangular with both ends rounded off. The thermistor film of temperature detection element 22 is made of at least one of, for example, vanadium oxide, amorphous silicon, polycrystalline silicon, spinel-type crystal structure oxide containing manganese, titanium oxide, yttrium-barium-copper oxide, and a nanocarbon material such as graphene or carbon nanotubes. Temperature detection element 22 may be, instead of a thermistor film, a diode film such as a silicon diode film, a thermocouple film, a thermopile film, or a pyroelectric film such as a lead zirconate titanate film.

Electromagnetic wave absorber 23 covers at least a part of (in the present embodiment, all of) temperature detection element 22. Electromagnetic wave absorber 23 is made of a dielectric such as aluminum nitride, silicon nitride, aluminum oxide, or silicon oxide, and absorbs the electromagnetic waves to be measured. The shape of electromagnetic wave absorber 23 will be described below.

As shown in FIG. 3C, first electrode layer 24X and second electrode layer 24Y are electrically connected to temperature detection element 22. First electrode layer 24X is electrically connected to wiring layer 32 of first arm part 31X, and second electrode layer 24Y is electrically connected to wiring layer 32 of second arm part 31Y. First and second electrode layers 24X and 24Y supply temperature detection element 22 with a current flowing in the in-plane direction (XY plane) of temperature detection element 22. First and second electrode layers 24X and 24Y can be made of, for example, a metal such as titanium or a conductive nitride such as titanium nitride. Although not shown in the drawings, other electrode layers may be provided on the side of temperature detection element 22 opposite that of first and second electrode layers 24X and 24Y. In this case, current flows through temperature detection element 22 in the film thickness direction (Z-direction).

As shown in FIG. 1, electromagnetic wave sensor 100 includes metal films 26 that are provided corresponding to respective electromagnetic wave detection elements 11. Metal films 26 are located on the side opposite to the side where the electromagnetic waves to be measured are incident with respect to electromagnetic wave detector 21. Metal films 26 are provided at least at positions that face electromagnetic wave detectors 21. A portion of the electromagnetic waves incident from second substrate 2 passes through electromagnetic wave detectors 21, is reflected by metal films 26, and then enters electromagnetic wave detectors 21, thereby enabling an increase of the electromagnetic wave absorption efficiency of electromagnetic wave detectors 21. Metal films 26 can be made of a material having high reflectivity for electromagnetic waves, examples of which include a single layer of tantalum, titanium, gold, nickel-chromium alloy, aluminum, silver, or a laminated film made of these materials.

### Configuration of Electromagnetic Wave Absorber 23

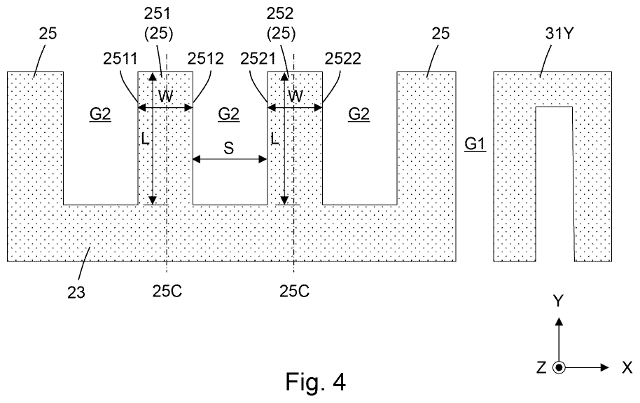

FIG. 4 is an enlarged view of area A of FIG. 3A. Referring mainly to FIGS. 3A to 3C and 4, the shape of electromagnetic wave absorber 23 is further described. Electromagnetic wave absorber 23 includes two protruding parts adjacent to each other in the X-direction and separated by second gap G2. In the following description, the two protruding parts are referred to as first protruding part 251 and second protruding part 252, and the protruding parts including first and second protruding parts 251 and 252 are referred to as protruding parts 25 when not distinguished. Electromagnetic wave absorber 23 may have three or more protruding parts 25 including first protruding part 251 and second protruding part 252, in which case the three or more protruding parts 25 are adjacent to each other in the X-direction, each pair separated by second gap G2. In this case, the length of each second gap G2 in the X-direction may be the same or may be different for each second gap G2. Second gaps G2 between two protruding parts 25 adjacent in the X-direction other than between first and second protruding parts 251 and 252 (e.g., in FIG. 4, second gap G2 between first protruding part 251 and protruding part 25 to the left of first protruding part 251, or second gap G2 between second protruding part 252 and protruding part 25 to the right of second protruding part 252) may be referred to as “the other second gap G2.” As shown in FIG. 3A, eight protruding parts 25 are provided in the present embodiment, four protruding parts 25 being provided on one side in the Y-direction with respect to temperature detection element 22 and the remaining four protruding parts 25 being provided on the other side in the Y-direction. The four protruding parts 25 on one side are arranged adjacent to each other in the X-direction separated by second gaps G2 each having the same length in the X-direction, and the four protruding parts 25 on the other side are also arranged adjacent to each other in the X-direction separated by second gaps G2 each having the same length in the X-direction. In the present embodiment, protruding parts 25 are provided only on electromagnetic wave absorber 23.

Viewed from the Z-direction, first protruding part 251 and second protruding part 252 each have a rectangular shape with central axis 25C in the Y-direction. As shown in FIG. 4, viewed in the Z-direction, first protruding part 251 has two sides 2511 and 2512 opposite each other in the X-direction and extending parallel to each other in the Y-direction, and second protruding part 252 has two sides 2521 and 2522 opposite each other in the X-direction and extending parallel to each other in the Y-direction. Side 2512 of first protruding part 251 and side 2521 of second protruding part 252 are opposite and parallel to each other. First protruding part 251 and second protruding part 252 have the same shape and size, but at least one of the shape and the size may be different.

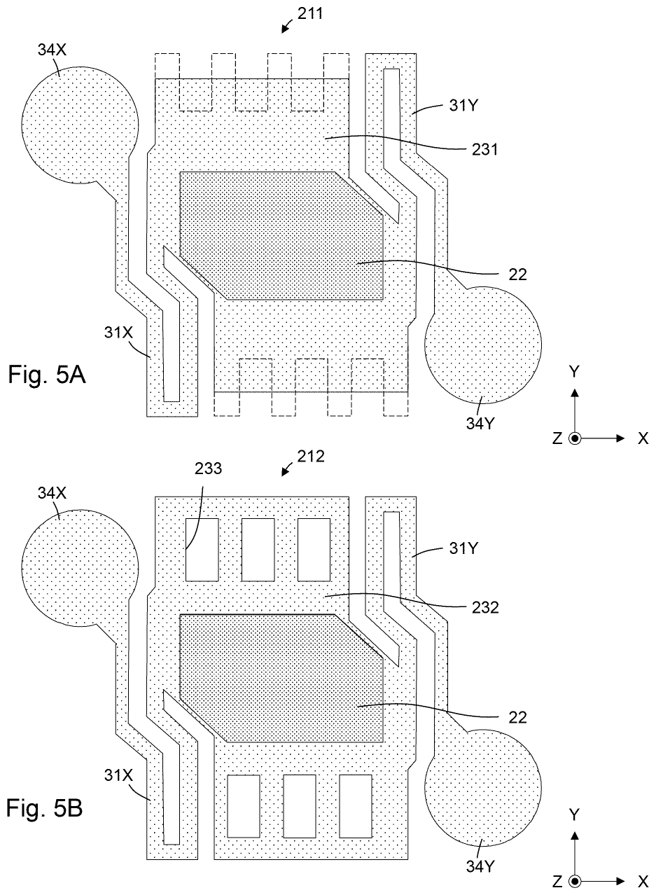

Electromagnetic wave absorber 23 has first and second protruding parts 251 and 252 adjacent to each other in the X-direction and separated by second gap G2, and as a result, the electromagnetic waves to be measured resonate between first and second protruding parts 251 and 252, and the electromagnetic waves to be measured are therefore easily concentrated on first and second protruding parts 251 and 252, whereby the electromagnetic wave absorption performance of electromagnetic wave absorber 23 is improved. FIG. 5A shows a schematic plan view of electromagnetic wave detector 211 of Comparative Example 1. In FIG. 5A, temperature detection element 22 is illustrated for convenience. The dashed lines show the outline of electromagnetic wave detector 21. The planar area of electromagnetic wave absorber 231 of Comparative Example 1 is the same as that of electromagnetic wave absorber 23 of the present embodiment, and therefore, the area of incidence into which electromagnetic waves enter is the same for electromagnetic wave absorber 23 of the present embodiment and electromagnetic wave absorber 231 of Comparative Example 1. In FIG. 5A, however, the upper and lower edges of electromagnetic wave absorber 231 of Comparative Example 1 are straight, and there are no protruding parts 25. Electromagnetic wave absorber 23 in the present embodiment has a high absorption efficiency of electromagnetic waves due to the resonance of the electromagnetic waves to be measured. This configuration improves the electromagnetic wave absorption performance of electromagnetic wave absorber 23, and further, increases the responsiveness of the temperature change of electromagnetic wave absorber 23 when the intensity of the incident electromagnetic wave fluctuates, thereby increasing the ability of electromagnetic wave detection element 11 to follow temperature changes that occur in response to fluctuations in the intensity of the electromagnetic waves.

Resonance of electromagnetic waves is likely to occur when length S in the X-direction of second gap G2 between first protruding part 251 and second protruding part 252 is less than or equal to the wavelength of the electromagnetic waves to be measured. Therefore, length S in the X-direction of second gap G2 between first protruding part 251 and second protruding part 252 may be less than or equal to the wavelength of the electromagnetic waves to be measured. Resonance of electromagnetic waves is likely to occur when width W of first and second protruding parts 251 and 252 (dimensions in the X-direction of first and second protruding parts 251 and 252) is less than or equal to the wavelength of the electromagnetic waves to be measured. Therefore, width W of first protruding part 251 and second protruding part 252 may be less than or equal to the wavelength of the electromagnetic waves to be measured. As described above, electromagnetic wave detection elements 11 in the present embodiment detect infrared rays, and the wavelength of the electromagnetic waves to be measured is therefore generally 8 to 14 μm. In the present embodiment, length S in the X-direction of second gap G2 between first and second protruding parts 251 and 252 may be 8 μm or less, and width W of first and second protruding parts 251 and 252 may be 8 μm or less.

Length L (dimension in the Y-direction) in the direction of protrusion of first protruding part 251 and second protruding part 252 may be greater than length S in the X-direction of second gap G2 between first protruding part 251 and second protruding part 252 (L>S). In other words, second gap G2 may be greater in the direction of protrusion (Y-direction) of first protruding part 251 and second protruding part 252. Length L in the direction of protrusion of first protruding part 251 may be greater than width W in the X-direction of first protruding part 251, and length L in the direction of protrusion of second protruding part 252 may be greater than width W in the X-direction of second protruding part 252 (L>W). In other words, first protruding part 251 and second protruding part 252 are shaped such that the direction of protrusion (Y-direction) is long.

In the present embodiment, protruding parts 25 are provided along the periphery of electromagnetic wave absorber 23. In order to compare this configuration with a case in which holes are provided inside electromagnetic wave absorber 23, a simulation using a finite element method was performed for electromagnetic wave detector 21 in the present embodiment shown in FIGS. 3A to 3C and electromagnetic wave detector 212 in Comparison Example 2 shown in FIG. 5B. In FIG. 5B, temperature detection element 22 is shown for convenience. In Comparative Example 2, rectangular holes 233 were provided inside electromagnetic wave absorber 232. The number of second gaps G2 between protruding parts 25 in the present embodiment and the number of holes 233 in Comparative Example 2 were the same, the planar shape of second gaps G2 and the planar shape of holes 233 were the same, and the area of second gaps G2 and the area of holes 233 were also equal. In other words, the area of electromagnetic wave absorber 232 in Comparative Example 2 was the same as that of electromagnetic wave absorber 23 in the present embodiment. The present embodiment and Comparative Example 2 had metal film 26. Infrared rays having a wavelength of 10 μm were incident from the directions shown in FIGS. 3B and 3C. Table 1 shows the results. “Temperature rise” indicates the average temperature rise of electromagnetic wave absorber 23 or 232 after the incidence of infrared radiation. Since metal film 26 was provided at the positions opposite electromagnetic wave detector 21 in the present embodiment and electromagnetic wave detector 212 in Comparative Example 2 and almost all infrared rays transmitted through electromagnetic wave absorber 23 or 232 were reflected by metal film 26, the infrared rays transmitted through metal film 26 and absorbed by metal film 26 may be considered zero. As a result, the infrared rays incident to electromagnetic wave detector 21, excluding the infrared rays reflected by the entire system including electromagnetic wave detector 21 and metal film 26, can be considered to have been absorbed by electromagnetic wave detector 21. Similarly, the infrared rays incident to electromagnetic wave detector 212, excluding the infrared rays reflected from the entire system including electromagnetic wave detector 212 and metal film 26, can be considered to have been absorbed by electromagnetic wave detector 212. “Infrared reflectivity” is the ratio of the infrared rays that were reflected by the entire system including electromagnetic wave detector 21 and metal film 26 to the infrared rays that were incident to electromagnetic wave detector 21, or the ratio of the infrared rays that were reflected by the entire system including electromagnetic wave detector 212 and metal film 26 to the infrared rays that were incident to electromagnetic wave detector 212. “Infrared absorptivity” is the ratio of the infrared rays excluding the infrared rays reflected by the entire system including electromagnetic wave detector 21 and metal film 26 to the infrared rays incident to electromagnetic wave detector 21, or the ratio of the infrared rays excluding the infrared rays reflected by the entire system including electromagnetic wave detector 212 and metal film 26 to the infrared rays incident to electromagnetic wave detector 212. Compared to Comparative Example 2, the present embodiment had a higher infrared absorptivity and was thus more efficient in absorbing infrared rays. As a result, a larger temperature rise is considered to have occurred than in Comparative Example 2. This result shows that the electromagnetic wave absorption performance of electromagnetic wave absorber 23 is improved by including first and second protruding parts 251 and 252 adjacent to each other and separated by second gap G2 in the X-direction. This improvement is thought to be due to the resonance of the electromagnetic waves to be measured between first and second protruding parts 251 and 252, and the ready concentration of the electromagnetic waves to be measured on first and second protruding parts 251 and 252.

TABLE 1

| | Temperature | Infrared | Infrared |
|---|---|---|---|
| | rise | reflectivity | absorptivity |
| Comparative | 0.57 C. | 35% | 65% |
| Example 2 | | | |
| First | 0.73 C. | 14% | 86% |
| embodiment | | | |

Other embodiments and other modifications will be described below focusing on points that differ from the first embodiment. Configurations and effects that are the same as those of the first embodiment will be omitted from the explanation.

### First Modification

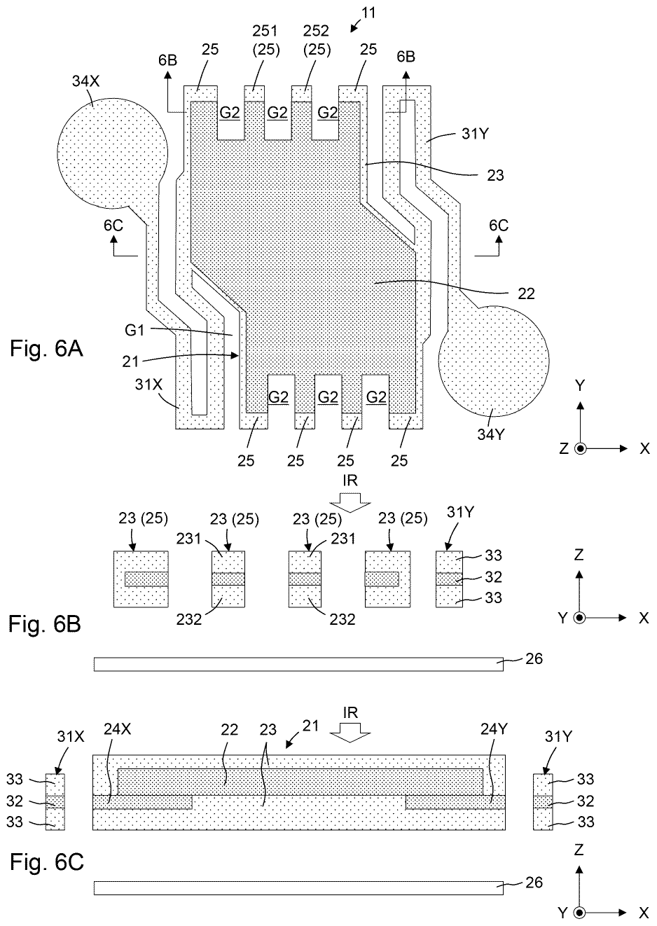

FIG. 6A is a schematic plan view of electromagnetic wave detection element 11 according to the first modification, FIG. 6B is a schematic cross-sectional view taken along line 6B-6B of FIG. 6A, and FIG. 6C is a schematic cross-sectional view taken along line 6C-6C of FIG. 6A. In FIG. 6A, temperature detection element 22 is shown for convenience. In the present modification, temperature detection element 22 is provided over most of the area of electromagnetic wave detector 21, and protruding parts 25 are provided on temperature detection element 22 and electromagnetic wave absorber 23. At protruding parts 251 and 252, where protruding parts 25 are provided on both sides in the X-direction, electromagnetic wave absorber 23 is divided into two parts 231 and 232 by temperature detection element 22. However, the resonance of electromagnetic waves occurs between first protruding part 251 and second protruding part 252 of electromagnetic wave detector 21 regardless of whether electromagnetic wave absorber 23 is divided by temperature detection element 22 and regardless of whether temperature detection element 22 is provided between the divided parts of electromagnetic wave absorber 23. Therefore, electromagnetic wave detection element 11 of the present modification can also improve the tracking of temperature changes that occur in response to fluctuations in electromagnetic wave intensity.

### Second Modification

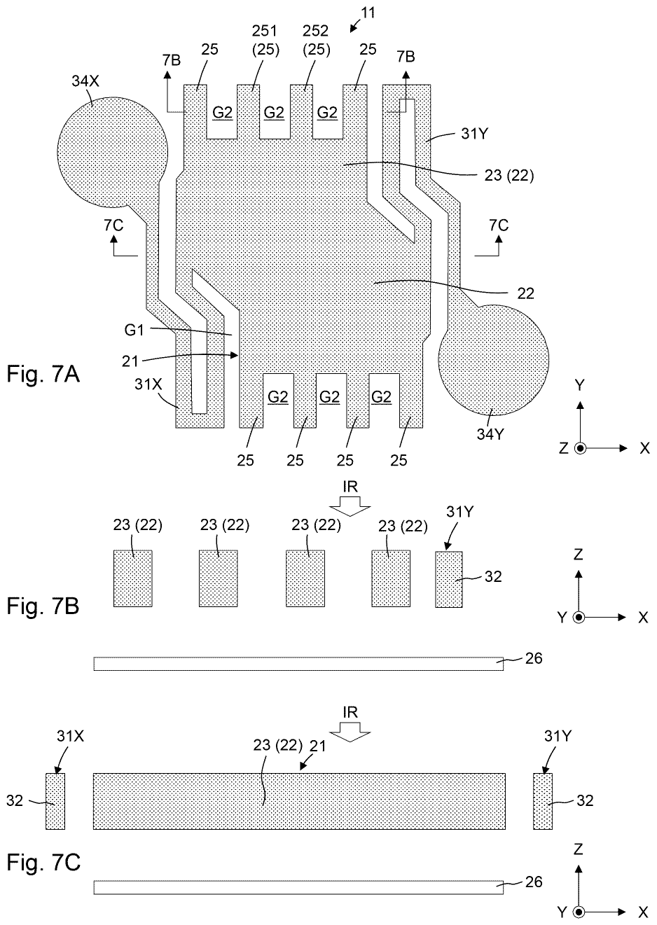

FIG. 7A is a schematic plan view of electromagnetic wave detection element 11 according to the second modification, FIG. 7B is a schematic cross-sectional view taken along line 7B-7B of FIG. 7A, and FIG. 7C is a schematic cross-sectional view taken along line 7C-7C of FIG. 7A. In the present modification, temperature detection element 22 is made of a material such as amorphous silicon that absorbs electromagnetic waves, and electromagnetic wave absorber 23 serves as temperature detection element 22 (temperature detection element 22 also serves as electromagnetic wave absorber 23). In the examples shown in FIGS. 7A to 7C, wiring layer 32 of first arm part 31X and wiring layer 32 of second arm part 31Y are also made of the same material as temperature detection element 22, and temperature detection element 22 that also serves as electromagnetic wave absorber 23 and wiring layers 32 of first and second arm parts 31X and 31Y are integrated. In the present modification, protruding parts 25 are provided on electromagnetic wave absorber 23 that also serves as temperature detection element 22. As described above, resonance of electromagnetic waves occurs between first and second protruding parts 251 and 252 of electromagnetic wave detector 21, and as a result, electromagnetic wave detection element 11 in the present modification can also enhance the tracking of temperature changes that occur in response to fluctuations in electromagnetic wave intensity.

### Third Modification

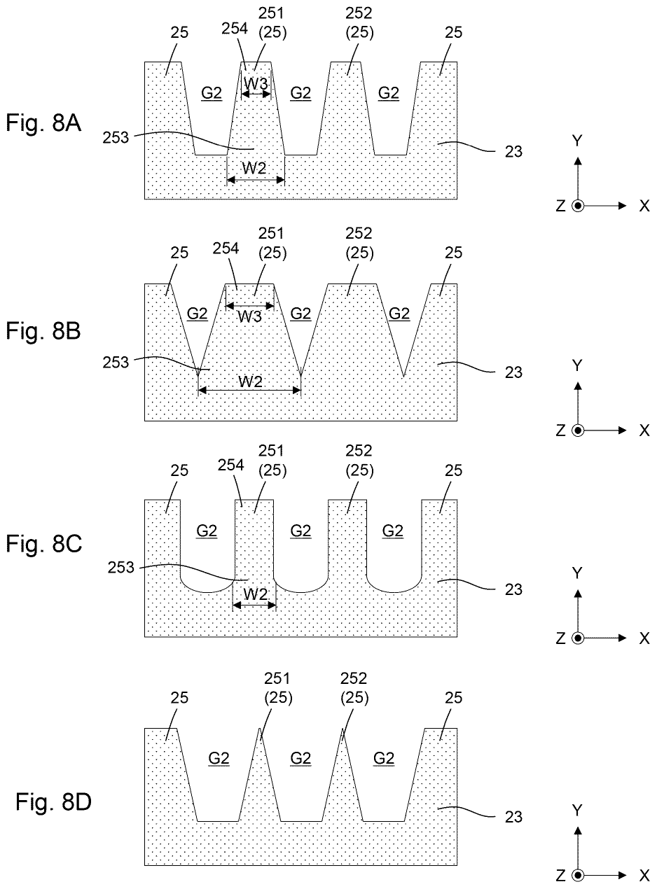

FIGS. 8A to 8D are partial schematic plan views of the electromagnetic wave detection element of the third modification. The planar shape of protruding parts 25 can take various shapes other than a rectangular shape. In the examples shown in FIGS. 8A and 8B, protruding parts 25 have a trapezoidal shape in which width W2 (dimension in the X-direction) of base parts 253 is wider than width W3 (dimension in the X-direction) of tip parts 254. In the example shown in FIG. 8A, adjacent protruding parts 25 are separated from each other at base parts 253, whereas in the example shown in FIG. 8B, adjacent protruding parts 25 contact each other at base parts 253. In the example shown in FIG. 8C, width W2 of base parts 253 of protruding parts 25 increases with progression away from tip parts 254, and the portion between base part 253 and tip part 254 is rectangular. In the example shown in FIG. 8D, protruding parts 25 are triangular in shape.

### Fourth Modification

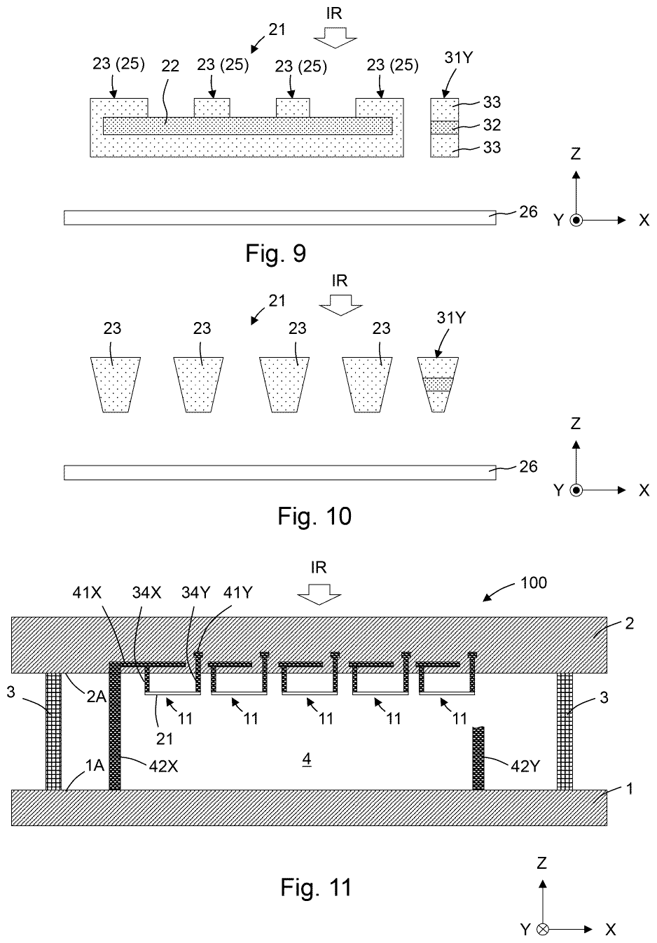

FIG. 9 shows a schematic cross-sectional view of the electromagnetic wave detection element of the fourth modification, this view corresponding to the cross-section taken along line 6B-6B of FIG. 6. Protruding parts 25 are provided only in a portion of the thickness direction (Z-direction) of electromagnetic wave detector 21. In other words, protruding parts 25 are provided only on the side of electromagnetic wave incidence of electromagnetic wave absorber 23 and not on temperature detection element 22 or on the opposite side of electromagnetic wave absorber 23 with respect to temperature detection element 22. In other words, in contrast to the first modification shown in FIG. 6, protruding parts 25 in the present modification are provided only on a part of electromagnetic wave absorber 23 in the thickness direction (Z-direction). Since resonance of electromagnetic waves occurs between two protruding parts 25 regardless of the position of protruding parts 25 in the thickness direction, electromagnetic wave detector element 11 in the present modification can also enhance the tracking of temperature changes that occur in response to fluctuations in electromagnetic wave intensity. For example, protruding parts 25 may be provided only on the side of electromagnetic wave absorber 23 that is opposite from the side of the electromagnetic wave incidence, in which case, the electromagnetic waves transmitted through the electromagnetic wave absorber 23 or reflected by the metal film 26 resonate between the two protruding parts 25, thereby increasing the absorption of electromagnetic waves. Alternatively, protruding parts 25 may be provided on both the side of electromagnetic wave incidence and the side of electromagnetic wave absorber 23 that is opposite from the side of the electromagnetic wave incidence. Although not shown in the drawings, the first embodiment shown in FIGS. 3A to 3C and the second modification shown in FIG. 7 can also have protruding parts 25 only on a portion of the thickness direction (Z-direction) of electromagnetic wave absorber 23.

### Fifth Modification

FIG. 10 shows a schematic cross-sectional view of the electromagnetic wave detection element of the fifth modification corresponding to the cross-section taken along line 3B-3B of FIG. 3A. The cross-sectional shape of protruding parts 25 changes in the Z-direction. In the illustrated example, protruding parts 25 are wider on the side of electromagnetic wave incidence and narrower on the side opposite to the side of electromagnetic wave incidence. Alternatively, protruding parts 25 may be narrower on the side of electromagnetic wave incidence and wider on the side opposite to the side of electromagnetic wave incidence.

### Second Embodiment

FIG. 11 is a schematic side view of electromagnetic wave sensor 100 according to the second embodiment. Electromagnetic wave sensor 100 includes first electrical connection members 42X and second electrical connection members 42Y (In FIG. 11, only one of second electrical connection members 42Y is shown, and regarding the illustrated second electrical connection member 42Y, only a portion in the Z-direction is shown). First and second electrical connection members 42X and 42Y are cylindrical conductors extending in the Z-direction between first and second substrates 1 and 2 and are electrically connected to ROIC. First wirings 41X and second wirings 41Y are provided on second substrate 2, and electromagnetic wave detection elements 11 are supported by second substrate 2. Each of first wirings 41X is connected to one corresponding first electrical connection member 42X, and each of second wirings 41Y is connected to one corresponding second electrical connection member 42Y. The configuration of each electromagnetic wave detector 21, first and second arm parts 31X and 31Y, first and second conductive pillars 34X and 34Y, and first and second wirings 41X and 41Y is the same as in the first embodiment. In the present embodiment, each electromagnetic wave detector 21 is supported by second substrate 2, and as a result, the heat transfer path from a local heat source such as a ROIC on first substrate 1 can be made longer than in the first embodiment, and the effect of heat from the local heat sources on temperature detection elements 22 can therefore be reduced. The present embodiment can be combined with the above-described first to fifth modifications.

### Modification of Second Embodiment

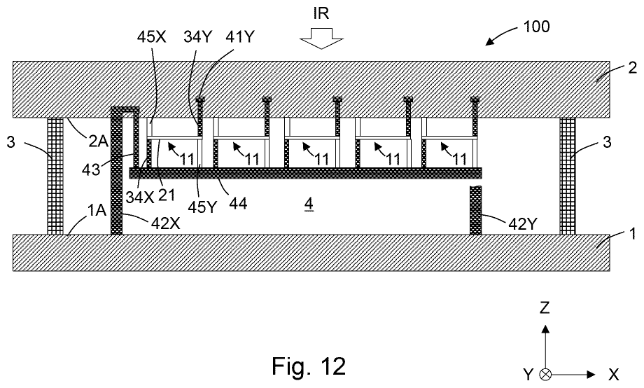

FIG. 12 is a schematic side view of electromagnetic wave sensor 100 according to a modification of the second embodiment. The present modification will be described focusing on points that differ from the second embodiment. Configurations and effects that are the same as those of the second embodiment will be omitted from the explanation. In the present modification, instead of first wirings 41X of the second embodiment, second wirings 44 extending in the X-direction are provided. Electromagnetic wave detection elements 11 are positioned in the Z-direction between the position of second wirings 41Y in the Z-direction and the position of second wirings 44 in the Z-direction. Each of second wirings 44 is electrically connected to one corresponding first electrical connection member 42X via third electrical connection member 43. Second wirings 44 have the same function as first wirings 41X but further serve as metal films 26 of the first embodiment. First intermediate layer 45X including an insulating layer is provided between first conductive pillar 34X and second substrate 2, and second intermediate layer 45Y including an insulating layer is provided between second conductive pillar 34Y and second wirings 44. Since second wirings 44, which also serve as metal films 26, are provided in the present modification, the electromagnetic wave absorption performance of electromagnetic wave absorber 23 is improved as in the first embodiment.

Although certain embodiments of the present disclosure have been illustrated and described in detail, it will be understood that various changes and modifications can be made therein without departing from the spirit or scope of the appended claims.

### LIST OF REFERENCE NUMERALS

11 electromagnetic wave detection element
21 electromagnetic wave detector
22 temperature detection element
23 electromagnetic wave absorber
25 protruding part
26 metal film
31X, 31Y arm part
32 wiring layer
100 electromagnetic wave sensor
251 first protruding part
252 second protruding part

1. An electromagnetic wave detection element, comprising:
a bolometer that includes an electromagnetic wave absorber; and
an arm part that includes a wiring layer electrically connected to the bolometer, wherein
a part of the arm part is arranged with a first gap between the arm part and the bolometer, and
the electromagnetic wave absorber includes first and second protruding parts adjacent to each other in a first direction and separated by a second gap.

2. The electromagnetic wave detection element according to claim 1, wherein a length in the first direction of the second gap between the first and second protruding parts is less than or equal to a wavelength of electromagnetic waves to be measured.

3. The electromagnetic wave detection element according to claim 1, wherein a length in the first direction of the second gap between the first and second protruding parts is 8 μm or less.

4. The electromagnetic wave detection element according to claim 1, wherein a width in the first direction of the first protruding part is less than or equal to the wavelength of the electromagnetic waves to be measured.

5. The electromagnetic wave detection element according to claim 1, wherein a width in the first direction of the first protruding part is 8 μm or less.

6. The electromagnetic wave detection element according to claim 1, wherein a length of the first protruding part in a direction of protrusion is greater than a length in the first direction of the second gap between the first and second protruding parts.

7. The electromagnetic wave detection element according to claim 1, wherein a length of the first protruding part in a direction of protrusion is greater than a width in the first direction of the first protruding part.

8. The electromagnetic wave detection element according to claim 1, wherein the electromagnetic wave absorber comprises three or more protruding parts including the first and second protruding parts, and another second gap is provided between two adjacent protruding parts in the first direction other than between the first and second protruding parts.

9. The electromagnetic wave detection element according to claim 1, further comprising a metal film located on a side opposite to a side where electromagnetic waves to be measured are incident with respect to the bolometer.

10. An electromagnetic wave detection element, comprising:
a electromagnetic wave detector that includes an electromagnetic wave absorber and that detects electromagnetic waves; and
an arm part that includes a wiring layer electrically connected to the electromagnetic wave detector, wherein
a part of the arm part is arranged with a first gap between the arm part and the electromagnetic wave detector, and
the electromagnetic wave absorber includes first and second protruding parts adjacent to each other in a first direction and separated by a second gap.

11. An electromagnetic wave sensor, comprising:
more than one of the electromagnetic wave detection element according to claim 1, wherein
the electromagnetic wave detection elements are arranged in an array.

12. An electromagnetic wave sensor, comprising:
more than one of the electromagnetic wave detection element according to claim 10, wherein
the electromagnetic wave detection elements are arranged in an array.
